(19) United States
(12) Patent Application Publication
(10) Pub. No.: US 2008/0116687 A1
(43) Pub. Date: May 22, 2008

(54) Sealed joining device

(76) Inventors: Georges Filippi, Merignac (FR); Dominique Bailly, Saint Regle (FR)

Correspondence Address: JACOBSON HOLMAN PLLC, 400 SEVENTH STREET N.W., SUITE 600, WASHINGTON, DC, 20004, US

(21) Appl. No.: 11/984,836

(22) Filed: Nov. 21, 2007

(30) Foreign Application Priority Data
Nov. 21, 2006 (FR) 06/10171

(51) Int. Cl. F16L 27/107

(52) U.S. Cl. 285/231

(57) ABSTRACT

A device adapted to join two sleeves (1, 3) in a sealed manner by at least one of their respective ends provided each with fastening means (4, 7) adapted to cooperate with joining means (10), characterized in that the said joining means (10) are comprised of and/or include at least one adjusting member (11) allowing at least one degree of freedom to a sleeve (1, 3) in relation to the other in the joined position. Specifically, the said joining means (10) are formed by at least one mobile connecting member (12) and at least one adjusting member (11) adapted to cooperate with the said fastening means (4, 7) provided at least at one end of a sleeve (1,3). The said at least one adjusting member (11) is at least a means for radial and/or axial and/or angular adjustment.

This invention belongs to the area of air-conditioning piping, and more particularly that of devices for the sealed joining of pipes or sleeves.

The pipes need to withstand pressure differences, vibrations and temperature differences and have sealed joining devices with certain physical properties to enable the constitution of an adjustable line of piping, at the same time giving it a certain rigidity of structure.

That is because these joining devices must withstand the assembly of the piping, the putting into service of the piping, handling during transport and the many locking/unlocking operations during maintenance. Further, when such devices are manufactured, standards relating to their mechanical strength in the area of resistance to vibrations, temperature, humidity, dust, fungal growth etc. and the environments specified by the end user are taken into account.

A first known joining system, which makes it possible to connect two pipes to each other, is comprised of a flexible sleeve and metal annular collars to be placed so that they overlap the said two pipes. The system makes it possible to assemble the pipes without too much play, and gives a certain degree of axial freedom while fitting the pipes. However, it does have some drawbacks such as the need to manage parts in addition to those of the piping, and to have enough of such parts in time and in the right dimensions for the required pipe diameter. Also, the system increases the time to install piping, given the need to carry out complex adjustments of the rings, and requires special tools. Thereafter, a verification step for checking their position on the areas of overlap of the sleeves in relation to the piping must be performed, which further adds to the installation time.

Moreover, the system does not provide perfect tightness, because it depends on the surface condition of the piping.

In a second joining principle that is known from FR 0305517 and FR 2857079, the piping may be assembled by means of quick closing clamps including two fixed annular collars on each end of the sleeve or pipe, characterized in that it comprises at least one mobile annular loose flange with hook-shaped pins that are regularly spaced around at least one of the said sleeves and adapted to join the said annular clamps together. This device adapted to join two sleeves in a sealed manner offers the benefit of making the piping rigid, thus making it possible to do away with the additional supports included initially. That benefit also turns out to be a drawback, because a number of adjustments are required upon assembly, as well as defect readjustments during operation. That is because such a device offers no degree of freedom at all.

This invention remedies the drawbacks of the prior art by providing a joining or closing device that combines strength and some degree of freedom, making it possible to assemble piping in a sealed and adjustable manner in a single operation.

Advantageously, the device according to the invention helps save considerable time because it does not call for the use of additional special tools or managing a stock of many former tightening devices and special tools.

The device according to the invention offers additional degrees of freedom by connecting the two pipes in a sealed fashion with radial and/or axial and/or angular flexibility while installing or assembling a set of piping and while putting it into service.

This invention makes it possible to have only one device containing the sleeve and the sealed adjustable closing system.

To that end, the device according to the invention, which is adapted to join two sleeves in a sealed manner by at least one of their respective ends, fitted each with fastening means adapted to cooperate with the joining means, is characterized in that the said joining means are comprised of and/or include at least one adjusting member allowing at least one degree of freedom to a sleeve in relation to the other in the joined position.

Specifically, the said joining means are formed of at least one mobile connecting member and at least one adjusting member designed to cooperate with the said fastening means provided at least at one end of a sleeve.

The said fastening means may be at least one annular clamp fixed to at least one end of a sleeve and the said at least one mobile connecting member may be a loose flange.

Advantageously, the said at least one adjusting member is at least a means to allow radial and/or axial and/or angular adjustment.

The said at least one adjusting member may be at least one flexible member, such as piping bellows or a hose or corrugated thermoformed member and may in addition include an exterior rigidity member on its contour.

Alternatively, the said at least one adjusting member is formed of at least one fastening piece including a double eccentric or at least one member each being comprised of a part with a reversed L shape having a thrust bearing at its end, and a ring.

Alternatively, the said at least one adjusting member is comprised of at least two half-balls or at least one spherical face formed at the interfaces of the annular clamp.

According to another arrangement, the said at least one adjusting member is at least a deformable member.

Further, the said at least one adjusting member according to the invention is integrated directly into the said fastening means or the said mobile member, or associated by bonding, clipping, nipping, tightening, bolting, crimping or by means of an additional axial thrust bearing.

The invention also relates to a set of piping comprising at least two sleeves including at least one device according to the invention.

Alternatively, the invention relates to a set of piping comprising at least two sleeves including at least one device according to the invention and at least one locking device.

The invention will be better understood in light of the description below, relating to illustrative examples of this invention that are not exhaustive in any case, by reference to the drawings enclosed, wherein:

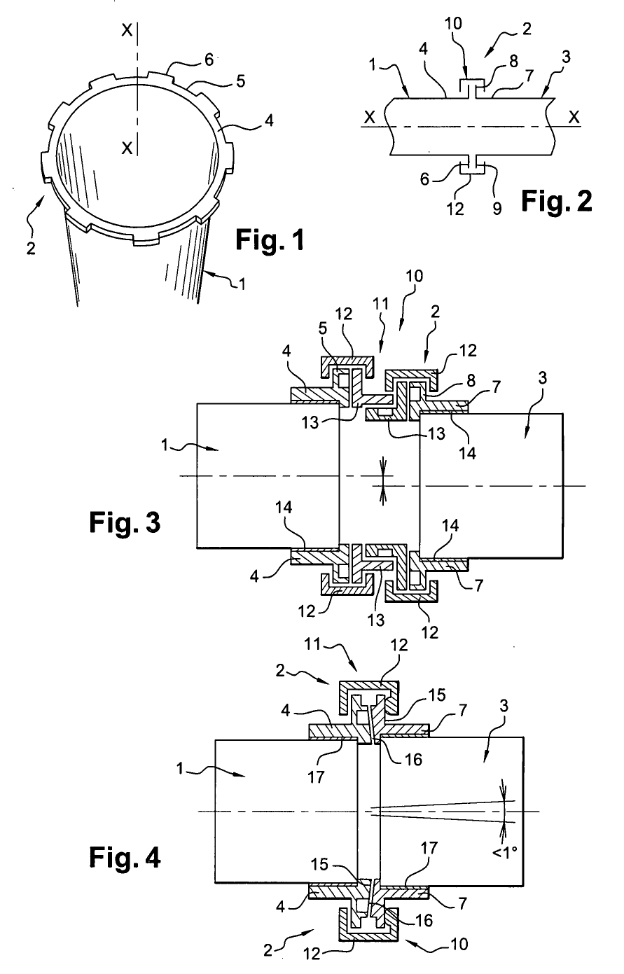

FIG. 1 represents a perspective view of the end of a sleeve with an annular closing system according to the prior art;

FIG. 2 is a schematic sectional view of two sleeves joined by a loose flange and two fixed annular clamps according to FIG. 1;

FIG. 3 is a sectional diagram illustrating two pipes joined by a first alternative of the device according to the invention that makes it possible to address the radial adjustment problem;

FIGS. 4 to 6 are sectional diagrams illustrating two pipes joined by three other alternatives of the device according to the invention that make it possible to address the angular adjustment problem;

FIG. 7 is a sectional diagram illustrating two pipes joined by a fifth alternative of the device according to the invention that makes it possible to address the axial adjustment problem;

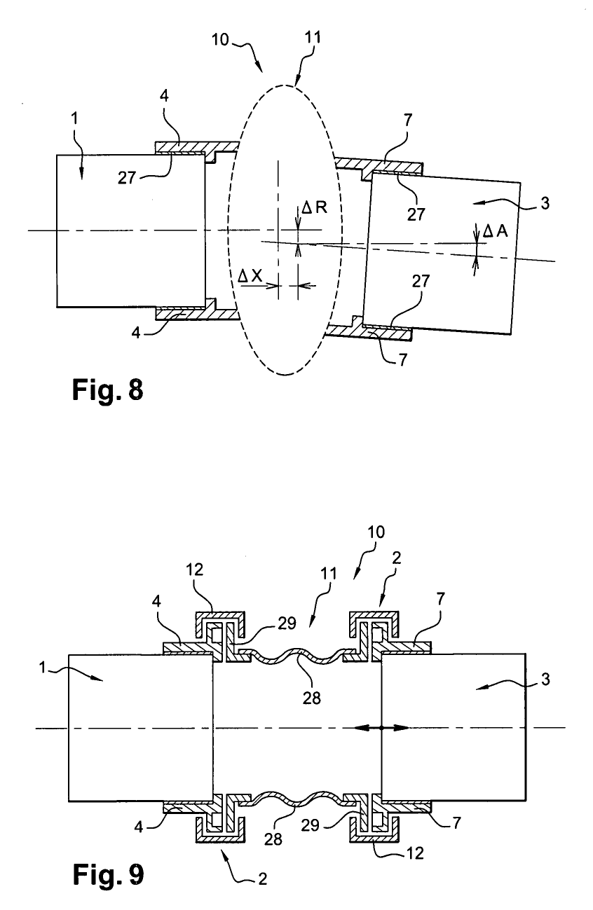

FIGS. 8 and 9 are sectional diagrams illustrating two pipes joined by another alternative of the device according to the invention that makes it possible to give the pipes any degree of freedom;

A joining device makes it possible to join two sleeves or a set of piping of the same diameter or of substantially equivalent diameters in a sealed manner.

FIG. 1 represents a sleeve 1 that is generally cylindrical in shape, with a longitudinal axis X-X according to the prior art.

A locking system 2 providing mechanical closing (according to FR 0305517 or FR 2857079) is arranged at the ends of a first sleeve 1 which are adapted to be connected to another sleeve 3.

Sleeves 1 and 3 have any appropriate cylindrical shape at one of their ends at least, that is they may for instance be bent, folded in half or U shaped.

The flexible sleeve 1 has at least at one of its ends one fastening means or fixed annular clamp 4 at least comprising an edge 5 with projecting members 6.

According to the representation of the prior art in FIG. 2, the end of a first sleeve 1 with a first fixed annular clamp 4 is joined to the end of a second sleeve 3 with at least a second fastening means or annular clamp 7.

The second fixed annular clamp 7 has an edge 8 with projecting members 9.

The first sleeve 1 and second sleeve 3, when they are assembled, have substantially the same longitudinal axis X-X and the same diameter.

The first annular clamp 4 and second annular clamp 7 may be substantially identical, that is with the same projecting members 6 and 9 and the same edge 5 and 8.

The first fixed annular clamp 4 and second fixed annular clamp 7 are joined and held next to each other by joining means 10.

In this invention, the joining means 10 are comprised of and/or include additionally at least one adjusting means 11 (not shown in FIGS. 1 and 2) and at least one mobile connecting member 12.

The mobile join may be a loose flange 12 that makes it possible to ensure that the longitudinal axis of the first sleeve 1 is coaxial with the longitudinal axis of the second sleeve 3.

The loose flange 12 is inserted in the second sleeve 3 and slides freely on that sleeve 3.

However, the loose flange 12 may also be provided so as to slide on the first sleeve 1.

This invention relates to a joining device that combines strength and some degree of freedom, and makes it possible to assemble piping in a sealed and adjustable manner in a single operation.

A “degree of freedom” means that independent movements of a sleeve that is mechanically connected to another sleeve remain possible.

The device according to the invention makes it possible to solve the problem of the association of different materials of the rigid locking system described earlier with at least one intermediate adjusting means or member, both integrated into a sleeve or pipe.

FIG. 3 is a sectional diagram illustrating two pipes joined by a first alternative of the device according to the invention that makes it possible to address the radial adjustment problem.

More precisely in FIG. 3, two pipes or sleeves 1, 3 are joined by at least one locking system 2 such as described in FIGS. 1 and 2, associated with at least one intermediate adjusting member 11 making it possible to give some flexibility or degree of freedom to the piping thus assembled.

According to this arrangement, the adjusting member 11 is integrated into the locking devices 2 of the sleeves. The adjusting member 11 may take the form of a fastening part 13 with a double eccentric making it possible to transform circular movement into straight movement.

Specifically, that fastening member 13 operates with the locking system 2 as two articulated parts that slide non coaxially on each other, thereby making it possible, thanks to the association of seals 14, to provide a connection that is flexible and sealed.

Alternatively, a gel-like flexible member (not shown but of a type known in itself) may be inserted between the said at least one mobile connecting member 12 and the said at least one adjusting member 11.

That intermediate fastening part 13 makes for a coaxially adjustable connection of at least two sleeves 1 and 3. That first alternative according to the invention makes it possible to better approach the misalignment of the two sets of piping, the axes of which are to be kept in alignment.

FIGS. 4 to 6 are sectional diagrams illustrating two pipes joined by three other alternatives of the device according to the invention that make it possible to address the angular adjustment problem.

In these cases, the two pipes or sleeves 1 and 3 are joined by at least one locking system 2, such as described in FIGS. 1 and 2, associated with at least one adjusting member 11 that gives a degree of angular freedom to the piping.

These alternatives make it possible to obtain a ball movement, that is a rotation of a few degrees in relation to the horizontal axis, for example, in order to solve perpendicular alignment problems while adjusting two sleeves.

FIG. 4 illustrates a device according to the invention integrating a locking device 2 as described previously comprising at its interface 15 at least one spherical face 16, enabling the angular rotation of the two sleeves thus joined.

Alternatively, the locking device may comprise on its interface 15 prominent means (not shown) in the form of local micro-variations in the surface, such as bumps and/or recesses that allow for instance the stepped vertical displacement of interfaces 15.

The fixed annular clamp(s) 4 or 7 may comprise adhesion means 17.

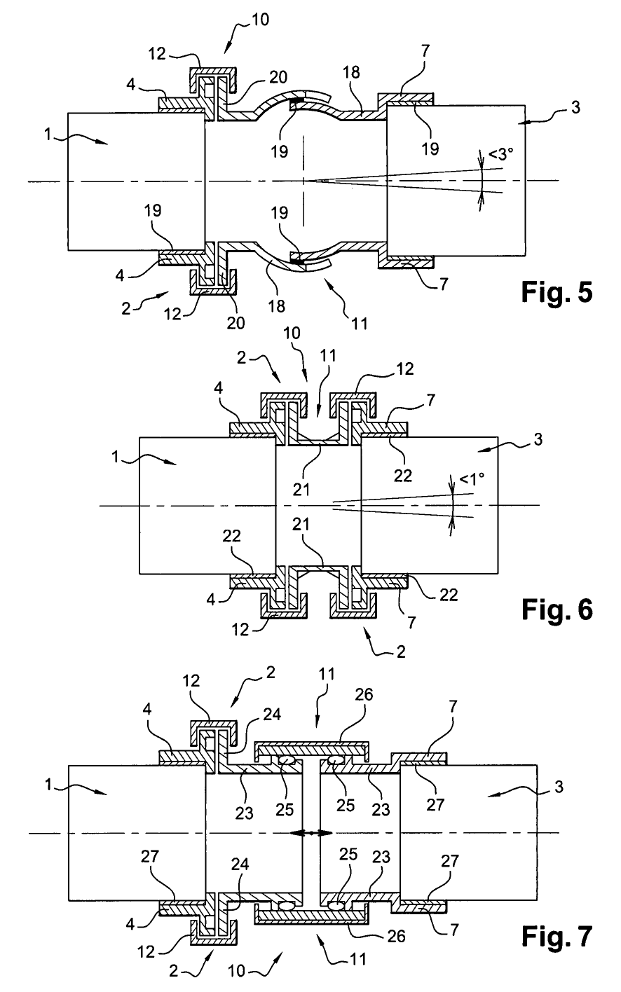

According to another alternative, as shown in FIG. 5, the two pipes 1 and 3 may be joined by means of at least two complementary circular arc or half ball members 18 associated with the locking device 2 described earlier.

In this arrangement, two half balls 18 are required and are in contact by means of seals 19 or any other system for sealing that is known in itself.

Alternatively, the half ball 18 may be integrated directly into the fixed annular clamp 4 or 7.

Preferably, a first half ball 18 of a first sleeve 3 is integrated with the fixed annular clamp 7 and a second half ball 18 is associated with the locking device 2 by means of a reverse L-shaped part 20 at its end.

FIG. 6 illustrates another alternative that makes it possible to address the problem of the angular adjustment of two sleeves joined to each other.

In this configuration, the two pipes or sleeves 1 and 3 are joined by at least one locking system 2 as described in FIGS. 1 and 2, associated with at least one deformable adjusting member 21 that makes it possible to give them a degree of freedom.

Preferably, that deformable member 21 has an overall U shape and makes it possible to join at least two locking devices 2.

The deformable member 21 is made of deformable material that makes it possible to make the join rigid, and at the same time give it some angular flexibility.

Alternatively, the deformable member 21 may form an integral part of at least one fixed annular clamp 4 or 7 and has a part of its U shape integrated into a fixed annular clamp.

Preferably, seals or adhesion means 22 are provided at the interface of the deformable member 21 and the locking system 2.

The FIG. 7 is a sectional view illustrating two pipes joined by a fifth alternative of the device according to the invention that makes it possible to address the problem of axial adjustment.

At least two sleeves 1 and 3 are joined by at least one locking system 2, associated with at least one adjusting means 11 making it possible to give them a degree of freedom along axis X-X.

In this configuration, the adjusting member 11 is assimilated with at least one member 23, each being comprised of:
a part 24 with a reverse L shape that has a thrust bearing 25 at their end (in contact with the annular clamp 4 or 7 and alternatively integrated into it),
a contact member or ring 26 making it possible to have some play relating to the pipe length tolerances.

The ring 26 locks in the two thrust bearings 25 of each sleeve at their end and over a certain length, enabling axial telescopic movement.

Alternatively, the ring clamps may have seals or adhesion means 27.

FIGS. 8 and 9 are sectional views illustrating two pipes joined by another alternative of the device according to the invention that makes it possible to give the pipes any degree of freedom.

At least two sleeves 1 and 3 are joined by at least a locking system 2 such as described in FIGS. 1 and 2, associated with at least one flexible member 28 making it possible to give them several degrees of freedom.

The said at least one flexible member 28 associated with at least one locking system 2 integrated into the sleeve 1 or 3 form the device according to the invention that makes it possible to perform:
axial adjustment in order to remove a gap of for example ΔX±5.0 mm between two ends of sleeves while assembling several sleeves;
radial adjustment in order to coaxially align two sets of piping, for example by ΔR±4.0 mm (in any direction);
angular adjustment making it possible to address the angular adjustment problem, for example ΔA±5° (in any direction) between the axes of the two pipes.

The flexible member 28 is associated with the locking system 2 by means of an intermediate part 29 that is L shaped.

Alternatively, the flexible member 28 may be integrated directly into at least one annular clamp 4 or 7 or bonded directly on the piping.

In this example, the joining device according to the invention is used to obtain radial and/or axial and/or angular flexibility.

The flexible member 28 may be for example flexible piping bellows.

It may be made of silicone, elastomer or another plastic material or any other flexible material or fabric of a type known in itself.

Alternatively, the flexible member 28 may be rigidified by means of an exterior rigid member, such as for example a plastic or metal spiral on its contour.

In other examples, the flexible member 28 may be thermoformed with corrugations or may be a hose.

Alternatively, the joining device comprises a thrust bearing or a bead or bellows on the sleeve as an additional adjusting member.

The joining device according to the invention comprising at least one locking system 2 and at least one adjusting means 11 is integrated directly into the ends of the sleeves 1, 3.

The sleeve 1 or 3 may be moulded over previously injected locking systems 2 containing at least one intermediate adjusting means 11.

Alternatively, the previously injected locking systems 2 are arranged inside a mould where an elastomer is injected.

According to another manufacturing mode, inside the same mould, the material of the locking systems, such as PEI, then an elastomer (thermoplastic or thermosetting, pure or reinforced) for the sleeve are injected.

When the joining device according to the invention is added to the annular clamps, it is joined mechanically, such as for instance by nipping, tightening, bolting, crimping, bonding or by means of an additional axial thrust bearing etc.

This invention also relates to a set of pipes comprising at least two sleeves 1, 3 with at least one device such as described above, that is at least one locking system 2 as described in FIGS. 1 and 2, associated with at least one adjusting member 11 making it possible to give them at least one degree of freedom.

Alternatively, this invention relates to a set of pipes including:
at least two sleeves 1, 3 including at least one device such as described above, that is, at least one locking system 2 such as described in FIGS. 1 and 2, associated with at least one adjusting member 11 making it possible to give them at least one degree of freedom, and
at least one locking device 2 such as described in FR 0305517 or FR 2857079.

The device according to the invention meets some mechanical stress requirements such as pressure, handling during locking and unlocking sets of piping, accelerations due to impacts and vibrations when putting the piping into service, and also requirements under standards such as resistance to fire, smoke, humidity, fungi and pollution depending on the environment in which it is used, such as for example sand, salt, dust etc.

1. A device adapted to join two sleeves (1, 3) in a sealed manner by at least one of their respective ends provided each with fastening means (4, 7) adapted to cooperate with joining means (10) that give at least one degree of freedom to a sleeve (1, 3) in relation to the other in the joined position, characterized in that the said joining means (10) are formed of at least one mobile connecting member (12) and at least one adjusting member (11).

2. A device according to the preceding claim, characterized in that the said fastening means (4, 7) are at least one annular clamp fixed to at least one end of a sleeve (1, 3).

3. A device according to claim 1, characterized in that the said at least one mobile connecting member (12) is a loose flange.

4. A device according to claim 1, characterized in that the said at least one adjusting member (11) is at least a flexible (28) or deformable (21) member.

5. A device according to the preceding claim, characterized in that the said at least one flexible member (28) is at least one piping bellows or hose or corrugated thermoformed member.

6. A device according to claim 4, characterized in that the said at least one flexible member (28) has an exterior rigidity member on its contour.

7. A device according to claim 1, characterized in that the said at least one adjusting member (11) is formed by at least one fastening part (13) including a double eccentric.

8. A device according to claim 1, characterized in that the said at least one adjusting member (11) is comprised of at least one member (23) each being formed by a part (24) with a reversed L shape having a thrust bearing (25) at its end, and a ring (26).

9. A device according to claim 1, characterized in that the said at least one adjusting member (11) is comprised of at least two half balls (18).

10. A device according to claim 1, characterized in that the said at least one adjusting member (11) has at least one spherical face (16) or prominent means formed on the interfaces (15) of the said fastening means (4, 7).

11. A device according to claim 1, characterized in that the said at least one adjusting member (11) is integrated directly into the said fastening means (4, 7) or the said mobile member (12) or associated by bonding, clipping, nipping, tightening, bolting, crimping or by means of an additional axial thrust bearing.

12. A set of piping comprising at least two sleeves (1, 3) including at least one device according to claim 1.

13. A set of piping according to claim 12, characterized in that it also comprises at least one locking device (2).
